(19) United States
(12) Patent Application Publication
(10) Pub. No.: US 2025/0193768 A1
(43) Pub. Date: Jun. 12, 2025

(54) CONNECTING TO A NON-TERRESTRIAL NETWORK

(71) Applicant: Telefonaktiebolaget LM Ericsson (publ), Stockholm (SE)

(72) Inventors: Athanasios KARAPANTELAKIS, Solna (SE); Ioannis FIKOURAS, Stockholm (SE); Jonas SEDIN, Brentford (GB); Konstantinos VANDIKAS, Solna (SE); Massimo CONDOLUCI, Solna (SE); Kristijonas CYRAS, San Jose, CA (US); Alessandro PREVITI, Stockholm (SE); Marin ORLIC, Bromma (SE); Alexandros NIKOU, Danderyd (SE); Lackis ELEFTHERIADIS, Valbo (SE)

(21) Appl. No.: 18/846,139

(22) PCT Filed: Jul. 5, 2022
(86) PCT No.: PCT/EP2022/068618

§ 371 Date: Sep. 11, 2024

(30) Foreign Application Priority Data
Mar. 22, 2022 (GR) 20220100254

(51) Int. Cl. H04W 40/18; H04L 41/046; H04W 64/00; H04W 76/20; H04W 84/06

(52) U.S. Cl. CPC H04W 40/18; H04L 41/046; H04W 64/00; H04W 76/20; H04W 84/06

(57) ABSTRACT

A method performed by a first network node in a terrestrial network, for determining whether a user equipment, UE, is to connect to a non-terrestrial network, NTN, includes obtaining a predicted capacity of the NTN for transmissions made by the UE. The method further includes determining whether to connect the UE to the NTN, based on the predicted capacity of the NTN. User equipments, network nodes, computer programs, computer program product, a carrier, and a system are also disclosed.

### TECHNICAL FIELD

This disclosure relates to methods, network nodes, a UE, computer programs, a carrier, a computer program product and a system. More particularly but non-exclusively, the disclosure relates to determining whether a user equipment (UE) is to connect to a non-terrestrial network (NTN).

### BACKGROUND

Satellite broadband services have grown recently, fueled by reduced satellite manufacturing costs and reduced costs for access to space. Various companies are promising low latency, high throughput global coverage, as they grow their orbital fleets of Low Earth Orbit (LEO) satellites. Incumbent players have also been active expanding their fleets of satellites.

In this environment, the standardization authority for mobile communications networks, known as third generation partnership project (3GPP), has been working on adapting 5^{th} Generation (5G) for satellite communications under the name Non-Terrestrial Network (NTN), which encompasses satellite communications, High-Altitude Platform Systems and Air-2-ground communications, but where the main focus is on satellite communications. The main work on this is how to enable 5G procedures to function over satellite scenario in a standalone environment where 5G connectivity is only provided through the satellite. Currently the view is that satellite networks can be used as a complement to TNs, i.e., as a redundant connection in case of a disaster scenario or when mobile devices, also known as User-Equipment—(UE), move out of range of the terrestrial mobile network.

How satellite networks (and NTNs at-large) can be integrated into terrestrial networks (TNs) is a current area of active research.

### SUMMARY

Generally, mainstream mobile device manufacturers are considering adding satellite connectivity to their devices, for example, to use limited services in emergency situations. Some manufacturers already produce Android™ smartphones with satellite support and there is a disruption in the satellite broadband business, driven by cheaper access to space due to reusability of launch vehicles.

Given the above, it is plausible to consider that while dense terrestrial deployments of 5G radio base stations will continue to be deployed, satellite connectivity will also exist, for cases where e.g., coverage of cellular network is insufficient, e.g., remote rural areas, or for areas where a natural or man-made disaster has incapacitated the terrestrial cellular network or finally for areas where demand for connectivity exceeds the supply e.g., crowded areas where people gather impromptu such as football events, concerts, protests, traffic jams, etc. In these cases where the mobile network is either overloaded or not available, satellite can help users maintain some level of connectivity service.

There are currently various different 3GPP-standardized techniques for steering traffic between different radio access technologies (RATs), three of which are described below:

Dual Connectivity (DC): In 5G New Radio (NR), dual connectivity allows mobile terminals to use both Long Term Evolution's (LTE) midband frequencies and NR's mmWave (highband) frequencies to provide mobility robustness and enhance throughput. Different configurations allow for redundant connectivity, both user plane and control plane traffic, on both 5G and LTE networks, or for splitting control plane traffic for LTE and user plane traffic for 5G. Proposals for placing 5G radio base station functionality on satellites, so-called “regenerative satellites”, is described, for example, in 3GPP study TR 38.821 “Solutions for NR to support non-terrestrial networks (NTN)”.

5G Access Traffic Steering, Switching and Splitting (ATSSS); ATSSS (3GPP TS 24.193) is a feature that can be supported by UEs and the 5GC network to route data traffic across 3GPP access and non-3GPP access networks. ATSSS Initially targets the integration of 3GPP access with Wireless Fidelity (Wi-Fi) access, even though ATSSS can be applied to any non-3GPP technology, targeting scenarios where higher broadband performance is delivered by using either, or both, 3GPP and non-3GPP links. ATSSS is a framework comprising a rule engine, which drives how traffic should be managed across available accesses. These specify whether a UE can use Wi-Fi or 3GPP NR Uu radio interface for data traffic according to the corresponding policies, specifying Quality of Service (QOS). Specifically, for every Service Data Flow, ATSSS uses UE Route Selection Policy (URSP) rules, then translated into Policy and Charging Control (PCC)/N4 rules, which specify which network link to use e.g., Wi-Fi or 3GPP, using a steering mode that consists of different types of strategies depending on network operator preferences e.g., load balancing where a share between two of the links can be specified; smallest delay, which uses the link with smallest delay; priority-based, which uses the link marked with higher priority; etc. From a user-plane aggregation point, an ATSSS capable UE establishes an Multi Access Protocol Data Unit (MA PDU) session supporting multi-access connectivity over 3GPP access and non-3GPP access networks via either ATSSS-LL i.e., above IP layer and/or Multipath Transmission Control protocol (MPTCP) (i.e., above IP layer) steering functionalities. Although ATSSS can be used with any 3GPP and non-3GPP access, ATSSS has not yet been considered in conjunction with satellite access when it comes to generating specific rules for handling traffic steering, switching and splitting among terrestrial access and non-terrestrial access such as satellite access.

UE-determined access: UEs are also capable of determining to which RAT they should connect to e.g., 3G, 4G, 5G, implicitly where the UE is configured to access a specific RAT, via rule-based approach such as “5G Auto” where the UE determines based on measured latency/throughput which type of connection to use for example fallback to 4G if there is no need for 5G. In addition, Home Subscriber Server (HSS) or Unified Data Management (UDM) can be used to determine a preferred profile for a user's connection thus letting a 3GPP network determine which kind of connection a UE should use. The common denominator here is that all these decisions are either determined or communicated to a 3GPP network and that is useful when it comes to providing continuity when changing from one connection type, or RAT type, to another which gives the impression to the user that no connection is broken, thus not impacting user experience. There is currently no UE-based mechanism that enables a UE to determine if a UE should use a TN or NTN based connection.

It is an object of embodiments herein to provide improved possibilities for a UE to communicate.

Thus, according to a first aspect herein there is a method performed by a first network node in a terrestrial network (TN), for determining whether a user equipment (UE) is to connect to a non-terrestrial network (NTN). The method comprises: obtaining a predicted capacity of the NTN for transmissions made by the UE; and determining whether to connect the UE to the NTN, based on the predicted capacity of the NTN.

According to a second aspect there is a method performed by a second network node in a TN, for determining whether a UE is to connect to a NTN. The method comprises: receiving, from the UE, as part of a Radio Resource Control (RRC) Connection attachment process, an indication of whether the UE has support for the NTN; and sending a second message comprising a request for DC to a first network node, to trigger the first network node to determine whether the UE is granted access to the NTN, based on a predicted capacity of the NTN.

According to a third aspect there is a method performed by a UE in a TN, for determining whether the UE, is to connect to a NTN. The method comprises: sending, to a second network node, as part of a Radio Resource Control (RRC) Connection attachment process, an indication of whether the UE has support for the NTN; and receiving a message from the second network node, comprising an indication of whether the UE is granted access to the NTN, wherein the indication was determined based on a predicted capacity of the NTN.

According to a fourth aspect there is a computer program comprising instructions which, when executed on at least one processor, cause the at least one processor to carry out a method according to any of the preceding aspects.

According to a fifth aspect there is a carrier containing a computer program according to the fourth aspect. The carrier comprises one of an electronic signal, optical signal, radio signal or computer readable storage medium.

According to a sixth aspect there is a computer program product comprising non-transitory computer readable medium having stored thereon a computer program according to the fourth aspect.

According to a seventh aspect there is a first network node in a TN, for determining whether a UE is to connect to a non-terrestrial network, NTN. The first network node being configured to: obtain a predicted capacity of the NTN for transmissions made by the UE; and determine whether to connect the UE to the NTN, based on the predicted capacity of the NTN.

According to an eight aspect there is a first network node in a TN, for determining whether a UE is to connect to a NTN. The first network node comprises a memory, comprising instruction data representing a set of instructions, and a processor configured to communicate with the memory and to execute the set of instructions. The set of instructions when executed by the processor cause the processor to obtain a predicted capacity of the NTN for transmissions made by the UE and determine whether to connect the UE to the NTN, based on the predicted capacity of the NTN.

According to a ninth aspect there is a second network node in a TN, for determining whether a UE is to connect to a non-terrestrial network, NTN. The second network node being configured to: receive, from the UE, as part of a RRC Connection attachment process, an indication of whether the UE has support for the NTN; and send a second message comprising a request for DC to a first network node, to trigger the first network node to determine whether the UE is granted access to the NTN, based on a predicted capacity of the NTN.

According to a tenth aspect there is a second network node in a TN, for determining whether a UE is to connect to a NTN. The second network node comprises: a memory, comprising instruction data representing a set of instructions, and a processor configured to communicate with the memory and to execute the set of instructions. The set of instructions, when executed by the processor, cause the processor to receive, from the UE, as part of a RRC connection attachment process, an indication of whether the UE has support for the NTN, and send a second message comprising a request for DC to a first network node, to trigger the first network node to determine whether the UE is granted access to the NTN, based on a predicted capacity of the NTN.

According to an eleventh aspect there is a User Equipment in a TN, for determining whether the UE is to connect to a NTN. The UE is configured to: send, to a second network node, as part of a RRC Connection attachment process, an indication of whether the UE has support for the NTN; and receive a message from the second network node, comprising an indication of whether the UE is granted access to the NTN, wherein the indication was determined based on a predicted capacity of the NTN.

According to a twelfth aspect there is a User Equipment in a TN for determining whether the UE is to connect to a NTN. The UE comprises a memory comprising instruction data representing a set of instructions and a processor configured to communicate with the memory and to execute the set of instructions. The set of instructions, when executed by the processor, cause the processor to send, to a second network node, as part of a RRC connection attachment process, an indication of whether the UE has support for the NTN, and receive a message from the second network node, comprising an indication of whether the UE is granted access to the NTN, wherein the indication was determined based on a predicted capacity of the NTN.

According to a thirteenth aspect there is a system in a TN, for determining whether a UE is to connect to a NTN. The system comprises a first network node and a second network node. The second network node is configured to receive, from the UE, as part of a Radio Resource Control, RRC, Connection attachment process, an indication of whether the UE has support for the NTN; the second network node is configured to send a second message comprising a Request for DC to a first network node, to trigger the first network node to determine whether the UE is granted access to the NTN, based on a predicted capacity of the NTN; the first network node is configured to obtain a predicted capacity of the NTN for transmissions made by the UE; the first network node is configured to determine whether to connect the UE to the NTN, based on the predicted capacity of the NTN; and the first network node is configured to send a third message to the second network node comprising an indication of whether the UE is allowed access, or denied access to the NTN, based on the result of determining whether to connect the UE to the NTN.

There is thus provided a system and method for Hybrid Terrestrial and Non-Terrestrial Cell Usage that takes the predicted capacity of the NTN network into account. The disclosure herein may be used to decide, for a UE, whether to steer traffic over the satellite network, i.e., NTN, link or terrestrial mobile network, i.e., TN, link. The system is based on predicting UE mobility and network coverage/availability and proactively enables UE to use one link over the other, based on spatiotemporal capacity of satellite network. There is thus provided a routing function for multi-connectivity traffic handling between Terrestrial and Non-Terrestrial Networks. The solutions herein allow for more prudent use of satellite resources, enable sustainable development of satellite services as user-plane data carriers, despite their inherently limited capacity when compared to TN networks, and open new opportunities for new sources of revenue for both satellite owners and terrestrial mobile network owners while at the same time not compromising QoS for end-users.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 illustrates an example first node according to some embodiments herein;

FIG. 2 illustrates a method performed by a first node according to some embodiments herein;

FIG. 3 illustrates a process according to some embodiments herein;

FIG. 4 illustrates a method according to some embodiments herein;

FIG. 5 illustrates a signal diagram according to some embodiments herein;

FIG. 6 illustrates an example second node according to some embodiments herein;

FIG. 7 illustrates an example method in a second node according to some embodiments herein;

FIG. 8 illustrates an example UE according to some embodiments herein;

FIG. 9 illustrates an example method in a UE according to some embodiments herein;

FIG. 10 illustrates a signal diagram according to some embodiments herein;

FIG. 11 illustrates a signal diagram according to some embodiments herein;

FIG. 12 illustrates a signal diagram according to some embodiments herein;

FIG. 13 illustrates an example carrier according to some embodiments herein; and

FIG. 14 shows an example computer program product according to some embodiments herein.

### DETAILED DESCRIPTION

As described in the background section, the integration of NTNs with traditional TNs is an ongoing area of research.

Regardless of the traffic steering approach, DC, ATSSS or UE-based, it is noted that in current approaches, there is an implicit assumption of high-availability and sufficient capacity on all network links. However, satellite networks, while having the benefit of broad coverage, have limited resources and they are also quite expensive in terms of e.g., operators leasing these resources from a satellite network vendor. Therefore, UEs should not always connect to satellite even if they are eligible for such connection, as this could risk utilizing precious satellite resources with no real reason. Instead, they can remain on TNs, when available, for most connections, and rely on satellite only when really needed.

From a DC perspective, the way DC is realized in the standards, is that it is always user-initiated. Upon completion of an initial attachment to one of the networks e.g., 4G, the UE indicates that it is possible to support DC e.g., by setting DCNR bit in UE Network Capability embedded at the RRC Connection Setup Complete message sent by the UE to e-Node B (eNB). Subsequently, eNB forwards the UE Network Capability to the mobility management entity (MME) in the core network, which then mediates connection to the 5G network. One of the issues here is that the only aspect that the MME checks with the UE is whether the latter is authorized to use 5G services via a NAS transport authentication procedure.

Similarly, in ATSSS, the ATSSS-enabled Policy Control Function (PCF) that compiles URSP and PCC/N4 rules which have information on the steering mode which selects one link over the other, is static or semi-static, i.e., rules are pre-determined based on network operator preferences and service knowledge. For example, currently URSP/PCC/N4 rules could look like “for service X, use 3GPP access; for service Y, use non-3GPP access; for service Z, split traffic between 3GPP and non-3GPP access”. These rules are generated based on pre-determined knowledge of service requirements and access capabilities e.g., service X is known to have requirements that could be met only by 3GPP access, service Y is known to have requirements that could be met also by non-3GPP access, as ATSSS has been designed for terrestrial fixed/wireless access. The only possibility for making such rules more dynamic is to e.g., use threshold Values, e.g., switch access from non-3GPP to 3GPP if a maximum Round Trip Time (RTT) is reached and/or a Maximum Packet Loss Rate is reached, but still such values are semi-static. As such, there is no consideration of aspects typical of non-terrestrial access, e.g., temporal availability and capacity of the satellite link.

Disclosed herein is a system and a method for deciding whether a UE is to steer traffic over a satellite network, e.g., NTN, link or terrestrial mobile network, e.g., TN, link.

As described in detail below, the system is based on predicting UE mobility and network coverage/availability, for example using deep reinforcement learning, and proactively enables the UE to use one link over the other, based on spatiotemporal capacity of the satellite network, traffic profile and mobility of the UE as well as the UE's requested QoS.

The system herein may be implemented in various different ways. For example, using DC wherein a UE is allowed to use the satellite link upon attach to a terrestrial mobile network. In this case the disclosed method can be incorporated as an extension to existing admission control for DC done in the 4G mobility management entity (MME)/5G Core Access and Mobility Management Function (AMF) and can work both with LTE and 5G mobile networks.

The system herein may also be implemented, for example, in an ATSSS-enabled policy transcription service, wherein upon verification of eligibility, URSP/PCC/N4 rules are written and enforced to allow an ATSSS-enabled UE to use a satellite service; enforcement of URSP/PCC/N4 rule is deferred for later; or a UE is denied satellite service (USRP/PCC/N4 rule does not include ATSSS provisions).

The system herein may also be implemented, for example, in a UE-based decision function which, given a UE that already has access to a satellite and 3GPP mobile network, enables the UE to determine which connection to use. In embodiments herein, over time, the UE learns to make the best decision on where to route its traffic based on availability of satellite and terrestrial mobile network, mobility and traffic and UE energy consumption information.

The former two approaches (DC, ATSSS) are suitable for networks where both TN and NTN are managed by an operator i.e., in a direct ownership business model, or in partner agreement with a satellite broadband services provider, whereas the latter UE-based approach can also be applied to environments where the networks belong to different administrative domains that do not necessarily communicate with each other. In such an example, a UE would maintain different subscriptions to these services. In addition, the UE based approach can be custom tailored to a specific UE with data that is trained locally on the UE which is more privacy friendly as opposed to aggregating information about each user in a 3GPP TN or in an NTN. In addition, such a system can scale better as opposed to a holistic model that is designed to learn from multiple UEs in a centralized fashion.

In more detail, the disclosure herein relates to a communications network or a telecommunications network. A communications network may comprise any one, or any combination of: a wired link e.g., ASDL, or a wireless link such as Global System for Mobile Communications (GSM), Wideband Code Division Multiple Access (WCDMA), Long Term Evolution (LTE), New Radio (NR), Wi-Fi, Bluetooth or future wireless technologies. A communications network may in some embodiments herein be a wireless network.

The communications network may comprise Terrestrial Network(s) (TN) and/or Non-terrestrial Network(s) (NTN). A NTN may for example comprise a satellite network configured for satellite communications. The skilled person will appreciate that these are merely examples and that the communications network may comprise other types of links.

A wireless network may be configured to operate according to specific standards or other types of predefined rules or procedures. Thus, particular embodiments of a wireless network may implement communication standards, such as GSM, Universal Mobile Telecommunications System (UMTS), LTE, and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

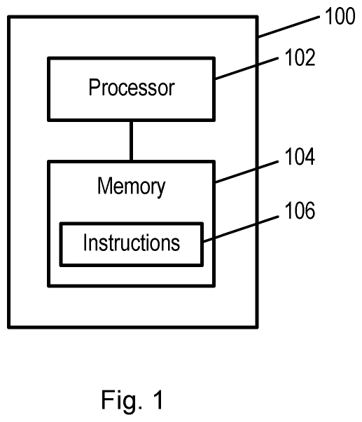

FIG. 1 shows an example first node 100 that may be used to determine whether a UE is to (e.g., should) connect to a non-terrestrial network, NTN. The first node 100 is configured (e.g., adapted, operative, or programmed) to perform any of the embodiments of the method 200 as described below. Generally, as will be described in more detail below, the first node 100 is configured to obtain a predicted capacity of the NTN for transmissions made by the UE; and determine whether to connect the UE to the NTN, based on the predicted capacity of the NTN.

In some embodiments, the first node may be implemented in hardware, e.g. completely in hardware.

The first node 100 herein comprises a processor e.g., processing circuitry or logic 102. The processor 102 may control the operation of the first node 100 in the manner described herein. The processor 102 can comprise one or more processors, processing units, multi-core processors or modules that are configured or programmed to control the first node 100 in the manner described herein. In particular implementations, the processor 102 can comprise one or a plurality of computer programs and/or hardware modules that are each configured to perform, or are for performing, individual or multiple steps of the functionality of the first node 100 as described herein.

The first node 100 comprises a memory 104. In some embodiments, the memory 104 of the first node 100 can be configured to store a computer program 106 with program code or instructions that can be executed by the processor 102 of the first node 100 to perform the functionality described herein. Alternatively, or in addition, the memory 104 can be configured to store any request, resource, information, data, signal, or similar that are described herein. The processor 102 may be configured to control the memory 104 to store any request, resource, information, data, signal, or similar that are described herein.

It will be appreciated that the first node 100 may comprise one or more virtual machines running different software and/or processes. The first node 100 may therefore comprise one or more servers, switches and/or storage devices and/or may comprise cloud computing infrastructure or infrastructure configured to perform in a distributed manner, that runs the software and/or processes.

It will be appreciated that the first node 100 may comprise other components in addition or alternatively to those indicated in FIG. 1. For example, in some embodiments, the first node 100 may comprise a communications interface. A communications interface may be for use in communicating e.g., via a communications network, with other nodes e.g., such as other physical or virtual computing nodes. For example, the communications interface may be configured to transmit to and/or receive from one or more nodes or network functions one or more requests, resources, information, data, signals, or similar. The processor 102 may be configured to control such a communications interface to make/receive such transmissions.

The first node 100 may be implemented in (e.g. form part of) a communications network. When implemented in a network, the first node may be referred to as a network node. In some embodiments herein, the first node 100, may be implemented in a management layer of a communications network.

The first node may host what is referred to herein as a Traffic Steering Function (TSF). As an example, the first node may host a Mobility Management Entity, MME or an Access and Mobility Management Function, AMF that performs the functionality described herein.

As another example, the first node may be comprised in the UE e.g., the method 200 described below may be performed by the UE itself.

As another example, the first node may host a Policy Control Function, PCF, and the functionality described herein may be performed as part of an Access Traffic Steering, Switching and Splitting, ATSSS, procedure by the PCF.

These are merely examples, however, and more generally, the node 100 may be implemented in any node/network device of a communications network. For example, the node 100 may comprise any component or network function e.g., any hardware or software, in a communications network suitable for performing the functions described herein. Examples of nodes include core network functions such as, for example, core network functions in a Fifth Generation Core network (5GC). It is realized that the first node 100 may be included as a node/device in any future network, such as a future 3GPP sixth generation communication network, irrespective of whether the first node 100 would there be placed in a core network or outside of the core network.

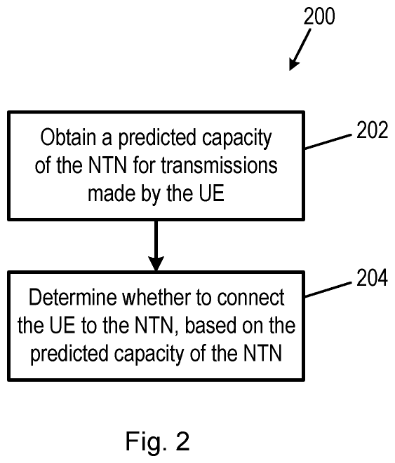

FIG. 2 illustrates a method 200 performed by a first node 100 in a terrestrial network, TN. The method 200 is for determining whether a UE is to (e.g. should) connect to a non-terrestrial network, NTN, e.g. or whether the UE should connect to another connection in the communications network, e.g. to part of the Terrestrial Network (TN). The method 200 is computer implemented. For example, the method 200 may be performed by a first node such as the first node 100 described above.

In brief, in a first step 202, the method 200 comprises obtaining a predicted capacity of the NTN for transmissions made by the UE. In a second step 204, the method 200 comprises determining whether to connect the UE to the NTN, based on the predicted capacity of the NTN.

The capacity of the NTN may be measured, for example, in terms of parameters such as the available throughput, packet drop rate and/or latency of the NTN. Available throughput may comprise the aggregate throughput on all available wireless carriers of the satellite for both uplink and downlink interfaces. Packet drop rate may comprise the percentage of packets that are dropped in a unit of time, e.g., every second due to connection issues e.g., weather. The latency, may, for example, be the one-way latency between the UE and the satellite for both uplink and downlink interfaces.

The capacity may be predicted by the first node. In other embodiments the capacity may be received from another node in the network.

The capacity of the NTN may be predicted using machine learning. The skilled person will be familiar with machine learning (ML) and machine learning processes for use in training machine learning models. ML is an approach that allows a programmer to implement a program by finding patterns in data samples. A program or model that is obtained through ML is called a ML model. The ML model, herein after referred to as model, can be used in various analysis tasks, for example classification or regression. A dataset of samples used to train the model is also known as a training set. The model is trained on the training data, using the machine learning process.

A ML process may comprise a procedure that is run on data to create a ML model. The ML process comprises procedures and/or instructions through which training data, may be processed or used in a training process to generate a ML model. The ML process learns from the training data. For example, the ML process may be used to determine how one set of parameters in the training data (input parameters of the model) are correlated with another set of parameters in the training data (output parameters of the model). The ML process may be used to fit the model to the training data. ML processes can be described using math, such as linear algebra, and/or pseudocode, and the efficiency of a ML process can be analyzed and quantized. There are many ML processes, such as e.g., algorithms for classification, such as k-nearest neighbors, algorithms for regression, such as linear regression or logistic regression, and algorithms for clustering, such as k-means. Further examples of ML models are Decision Tree models and Artificial Neural Network models. ML algorithms can be implemented with any one of a range of programming languages.

The model, or machine learning model, may comprise both data and procedures for how to use the data to e.g., make the predictions described herein. The model is what is output from the ML (e.g., training) process, e.g., a collection of rules or data processing steps that can be performed on the input parameters in order to produce the output. As such, the model may comprise e.g., rules, numbers, and any other algorithm-specific data structures or architecture required to e.g., make predictions.

Different types of ML models take different forms. Some examples of ML processes and models that may be used herein include, but are not limited to: linear regression processes that produce models comprising a vector of coefficients (data) the values of which are learnt through training; decision tree processes that produce models comprising trees of if/then statements (e.g. rules) comprising learnt values; and neural network models comprising a graph structure with vectors or matrices of weights and biases with specific values, the values of which are learnt using ML processes such as backpropagation and gradient descent.

Thus, step 202 may comprise predicting capacity of the NTN using a second model trained using a second ML process that predicts the capacity of the NTN to service the UE based on previous capacity of the NTN to service the UE. In some embodiments, the second model may be a second machine learning model.

Different algorithms can be used, for example simple regression in case the data fit a distribution, e.g., bell curve/normal distribution, or more sophisticated neural network to detect more complex patterns. In the latter case, recurrent neural networks that predict sequences of data (sequence to sequence) would be a considered implementation given that the dataset is a time series. The prediction time horizon is set by LOOKAHEAD_TIME parameter (otherwise referred to herein as the time interval). In one embodiment the time interval is determined a priori to system deployment. It can be set to e.g., one or several hours or one day into the future. Each datum used as input to the ML models, is therefore a sequence in the past of input that is arbitrarily long but output of LOOKAHEAD_TIME long. The sampling time of data is also variable.

The second model may take a sequence of previous capacity values as input and output a sequence of predicted values for the time interval following the previous capacity values. In other words, the second model may be a sequence to sequence model, such as a recurrent neural network. See paper by Alex Graves entitled: “Generating Sequences With Recurrent Neural Networks”; arXiv: 1308.0850.

More generally, the second model (otherwise referred to herein as the second model) can be any type of classification or regression model, trained using a supervised or semi-supervised learning process. For example, the second model can be a deep neural network, see paper by Schmidhuber (2015) entitled: “Deep learning in neural networks: An overview” Neural Networks Volume 61, January 2015, Pages 85-117.

The second model has been trained on (e.g. using) a second dataset. The second dataset comprises training data examples, each training data example comprises an example set of input parameters and a ground truth value or label for said training data example. The second model may have been trained to predict the capacity of the NTN using training data examples, each training data example comprising: example previous (e.g., historical) capacity values of the NTN and corresponding ground truth values of the capacity at a time interval (or “look-ahead-time”) subsequent to the previous capacity values. The second model may be trained using such training examples to predict a capacity of the NTN at a time interval equal to the time interval in the future from the input value(s). The second model may be trained in real time, or near real-time (e.g., in response to new data points becoming available), on historical data pertaining to whether the NTN historically had capacity for transmissions by the UE.

In some embodiments, the method may further comprise obtaining UE parameters. In this sense, UE parameters may comprise any one or combination of the following parameters: a location for the UE, a predicted throughput of the UE, coverage of a TN at the location for the UE, and a Quality of Service, QoS, requirement of the UE. In some embodiments, all of the aforementioned UE parameters are obtained, in other words, the method 200 may comprise obtaining a location for the UE, a predicted throughput of the UE, coverage of a TN at the location for the UE, and a QoS requirement of the UE. In embodiments where UE parameter(s) are obtained, step 204, determining whether to connect the UE to the NTN, may thus be further based on the UE parameter(s).

The location for the UE may be a current location, or a prediction of where the UE will be located at a future time point (e.g., corresponding to the time interval, described above). For example, a prediction of the location of the UE may be determined from location and mobility characteristics of the UE. E.g., by obtaining a current location and a bearing (direction of movement). Bearing and velocity can both be extracted from the recent history of handovers from cell to cell, information contained already in the mobility management function.

In other words, in some embodiments, the method 200 may comprise obtaining a location for the UE by predicting a location of the UE at a future time point, based on a trajectory of the UE. The predicted throughput of the UE and the predicted capacity of the NTN are predicted for the same future time point.

As an example: Handover history for UE with IMSI 082920202886455145 may be as follows:

| Serving Cell ID, location <lat, long> | Target Cell ID, location <lat, long> | Time |
|---|---|---|
| 2224, <38.298559, 21.908433> | 2225, <39.298559, 22.908433> | 2021-12-12 10:10 |
| 2225, <39.298559, 22.908433> | 2226, <38.398559, 22.008433> | 2021-12-12 10:15 |
| 2226, <38.398559, 22.008433> | 2227, <39.998559, 23.118433> | 2021-12-12 10:20 |
| 2227, <39.998559, 23.118433> | 2228, <39.768559, 23.658433> | 2021-12-12 10:25 |

Based on this information, it is possible to calculate the distance between the cells, (e.g., using haversine distance formula), and dividing it by the time one can deduce the velocity. Bearing can also be calculated, e.g. according to the following formula:

$$θ = a tan 2 ( sin Δ λ \cdot cos φ 2 , cos φ1 \cdot sin φ2 - sin φ1 \cdot cos φ2 \cdot cos Δλ )$$

where φ1,λ1 is the start point, φ2,λ2 the end point, and Δλ is the difference in longitude. In another embodiment the same calculations can be done using data from the mobile devices, e.g., GPS.

The TN coverage map may be obtained, for example, from an Operations Support System (OSS). The TN coverage map, or Operator coverage map, is a geographical map indicating areas of coverage and a spatial assessment of that coverage (e.g., in dBm, or using a qualitative 1-5 measurement system, etc.). A coverage map can be a list of bounding boxes, i.e., polygons with edges expressed as <latitude, longitude> tuples).

The QoS requirement of the UE can be obtained from Policy and Charging Control (PCC) rules stored in the Policy and Charging Rules Function (PCRF)/Policy Control Function (PCF). The rules used herein may have a Service Description Filter (SDF) that filters on a particular UE, or a group of UEs that the particular UE is a member of. PCC rules can indicate the QoS policy of a UE in terms of guaranteed bitrate (and guaranteed amount of throughput), uplink/downlink or both directions of traffic, latency and packet drop rate ceiling as well as priority over other policies.

The throughput of the UE may be predicted using ML. For example, the method 200 may comprise obtaining a predicted throughput of the UE by: predicting the throughput using a first model trained using a ML process that predicts the throughput at a predetermined future time interval, based on previous throughput of the UE. Alternatively, the throughput may be predicted by the UE itself and sent to the first node in a first message. In such an example the UE may have predicted the throughput using a first model trained using a ML process that predicts the throughput at a predetermined future time interval, based on previous throughput of the UE. Generally, the first model may be trained in real time, or near-real-time, on historical data for the UE. For example, the first model may be trained using training data examples, each training data example comprising an example set of input parameters and a ground truth value or label for said training data example. The first model may have been trained to predict the throughput of the UE using training data examples, each training data example comprising: initial historical throughput value(s) of the UE and subsequent throughput values of the UE at the predetermined time interval after the initial historical values. The first model may also be referred to herein as the UE traffic profile predictor.

Example inputs and outputs (e.g. example training data) of a “datum” to UE traffic profile predictor are as follows:

Input: list_of [avg_dl, avg_ul, time_from, time_to] Output
(discrete space): [TIME(from-to mins), ul_bucket, dl_bucket]
[11.2 MBps, 4.3 MBps, 2020 Oct. 10 10:10, 2020 Oct. 10 10:15]
[0-10, 10-12 Mbps, 3-4 Mbps]
[11.8 MBps, 4.0 MBps. 2020 Oct. 10 10:15, 2020 Oct. 10 10:20]
[10-20, 14-16 Mbps, 5-6 Mbps]
[11.6 MBps, 4.2 MBps, 2020 Oct. 10 10:20, 2020 Oct. 10 10:25]
[20-30, 8-10 Mbps, 4-5 Mbps]
[11.1 MBps, 5.0 MBps, 2020 Oct. 10 10:25, 2020 Oct. 10 10:30]

Where avg_dl and avg_ul represent the average downlink and average uplink of the UE in the time interval between time_from and time_to. During training many, e.g., hundreds or thousands, of training examples may be used to create/train the first model.

In this example, the model treats uplink and downlink differently. In terms of input, 20 minutes' worth of data is provided, each sample in the sequence describing a 5-minute average of uplink and downlink throughput. In the output, the LOOKAHEAD_TIME is 30 minutes, and there exist 3 time “buckets” of first 10, next 10 and final 10 minutes. For each time bucket there exist different ranges of uplink and downlink throughput that the UE is predicted to exhibit. Using the example training data above, a sequence-to-sequence model may be trained that has a discrete output space of a finite set of classes.

The skilled person will appreciate that this is merely an example, and that many different other configurations are possible, based on different training data examples. For example, instead of separate downlink and uplink values, the first model may take as input, and provide as output, aggregate throughput values.

The first model may be a sequence to sequence model, as was described above with respect to the second model. For example, the first model may be a recurrent neural network that takes a sequence of historical throughput values of the UE as input and provides as output a predicted sequence of throughput values for the UE.

Generally, a separate model may be trained for each UE, implying that the first node (e.g. TSF) would train multiple models, one per UE. It is also possible for the first node to train one model that applies to all UEs. In that case, a unique identifier for the UE would be part of the input. Examples of such unique identities are the International Mobile Subscriber Identity (IMSI), Temporary-IMSI (T-IMSI), International Mobile Equipment Identity (IMEI), or the Media Access Control (MAC) address. Other examples of unique identifiers include but are not limited to a device product number, a device serial number, or an IP-Address (that is unique to the network). The first model itself would also need to be more complex (e.g., with more layers and/or larger number of connections between the layers).

Turning back to the method 200 and to step 204, in step 204 the method 200 comprises determining whether to connect the UE to the NTN, based on the predicted capacity of the NTN. As noted above, in embodiments where one or more UE parameters are obtained (which, as noted above, may comprise a location for the UE; a predicted throughput of the UE; coverage of a TN at the location for the UE; and/or a QoS requirement of the UE), step 204 may further be based on the UE parameters.

In some embodiments, the step of determining 204 whether to connect the UE to the NTN may comprise determining an action, wherein the action indicates that: the UE is to connect to the NTN; the UE is to connect to the TN; or that the determination of whether to connect the UE to the NTN should be deferred for a first time interval. If the determined action is that the determination of whether to connect the UE to the NTN should be deferred for a first time interval, then the method 200 may be repeated after the first time interval has expired.

For example, in some embodiments, the action may indicate that the decision should be deferred for the first time interval if the predicted throughput of the UE is less than the predicted capacity of the NTN, but the QoS requirement of the UE cannot be met by the NTN. The first time interval may be predetermined (e.g. a fixed/configured time period after which the method 200 should be repeated), randomly chosen, or chosen in some other manner, for example, according to the magnitude of difference between the QoS requirement and the capacity of the NTN.

In some embodiments, the action may indicate that the TSF should negotiate the QoS requirements of the UE (e.g., with the MME or PCF). For example, it is possible for the TSF to negotiate a lower QoS to admit a UE for DC in case the predicted capacity of the satellite is not enough to cover the predicted throughput of the UE. In one embodiment, the TSF could calculate the difference between the predicted throughput of the UE and the predicted capacity of the satellite network. In another embodiment, a fairness-based algorithm could calculate the difference with some margin left for other UEs, or it can admit UEs to DC in a round-robin fashion.

In some embodiments, the determination in step 204 may be made using a discrete-time stochastic control process or Markov decision problem with unknown transition probability solver. These are dynamic programming-type algorithms—a popular category of which is deep reinforcement learning, deep RL which is described in the paper by Kai Arulkumaran et al. entitled: “A Brief Survey of Deep Reinforcement Learning”; arXiv: 1708.05866. See also paper by Wang, Hn., Liu, N., Zhang, Yy. et al. entitled: “Deep reinforcement learning: a survey”. Front Inform Technol Electron Eng 21, 1726-1744 (2020).

As such, in some embodiments, the discrete-time stochastic control process may be a reinforcement learning, RL, process performed by a RL agent. The skilled person will be familiar with reinforcement learning and reinforcement learning agents, however, briefly, reinforcement learning is a type of ML process whereby a reinforcement learning agent e.g., an algorithm, is used to perform actions on a system, such as a communications network, to adjust the system according to an objective which may, for example, comprise moving the system towards an optimal or preferred state of the system. The reinforcement learning agent receives a reward based on whether the action changes the system in compliance with the objective e.g., towards the preferred state, or against the objective e.g., further away from the preferred state. The reinforcement learning agent therefore adjusts parameters in the system with the goal of maximising the rewards received.

Put more formally, a reinforcement learning agent receives an observation from an environment in state S and selects an action to maximize the expected future reward r. Based on the expected future rewards, a value function V for each state can be calculated and an optimal policy IT that maximizes the long-term value function can be derived.

In the context of this disclosure, in some embodiments herein, a reinforcement learning agent may be used to predict an action with respect to whether the UE should connect to the NTN. The environment may comprise e.g., the network conditions in the communications network, the conditions in which the communications network is operating and/or the conditions in which devices connected to the communications network are operating. In such embodiments, the state information provided as input to the RL agent comprises the predicted capacity of the NTN and the UE parameters, if applicable. The actions output by the RL agent may be selected from the actions listed above, e.g., to recommend that the UE should connect to the NTN, that the UE should connect to the TN or that the determination should be deferred for the first time interval.

Generally, the reinforcement learning agent may receive feedback in the form of a reward or credit assignment every time it makes a determination of whether the UE should connect to the NTN, e.g., every time it proposes an action. Rewards may be positive, e.g., providing positive feedback, or negative, e.g., penalising or providing negative feedback to the agent. Rewards may be assigned based on a reward function that describes the rewards that are given for different outcomes. As noted above, the goal of the reinforcement learning agents herein is to maximise the reward received.

The skilled person will be familiar with reward functions, but in brief, a reward function sets out how different outcomes or changes to the environment should be rewarded in response to an action predicted by the RL agent, for a given state. Generally, a reward is given as a result of an action a and state s, in some cases also this can be written as reward(R) for R(s,a,), and for the future state R(s,a,s′).

In some embodiments, an action that results in the QoS requirement of the UE being met results in a higher reward than an action that results in the QoS requirement of the UE not being met. For example, a reward function may be set up to award +1 to the RL agent if the QoS requirement is met, and −1 if the QoS is not met.

For example, an action that results in the QoS requirement not being met may result in a negative reward. In this way, the RL agent may be encouraged to select actions that meet the QoS of the UE.

In some embodiments, an action that results in the QoS requirement of the UE being met by the TN results in a higher reward than an action that results in the QoS requirement of the UE being met by the NTN. In this way, the RL agent may be encouraged to use the TN wherever possible in order to meet the QoS requirements of the UE, saving on cost. For example, a reward function may be set up to award +10 to the RL agent if the QoS requirement is met by the TN, and +5 if the QoS is met by the NTN.

In some embodiments, an action that results in higher energy usage of the UE receives a lower reward than an action that results in lower energy usage of the UE. In this way, a reward function may be designed to optimise energy consumption of the uplink transmission of the UE (transmission of data to TN and NTN consumes different amounts of energy). For example, a reward function may be set up to award +2 to the RL agent if the energy usage is below a threshold energy, and −1 if the energy usage is above the threshold energy usage.

In some embodiments, an action that results in a higher transmission cost receives a lower reward than an action that results in a lower transmission cost. In this way, the reward may be used to optimise cost. This is as transmission of data through NTN generally costs more than through a TN. For example, a reward function may be set up to award +2 to the RL agent if the cost below a cost threshold, and −1 if the energy usage is above the cost threshold.

The skilled person will appreciate that the reward values above are merely examples and that a reward function may be created in many ways, for example, using a combination of the principles described above for example, via a weighted combination of parameters. Furthermore, a reward function may be normalised e.g. between 0 and 1. A reward function may be designed by an Engineer and set up differently dependent on the particular optimisation goals for the particular communications network.

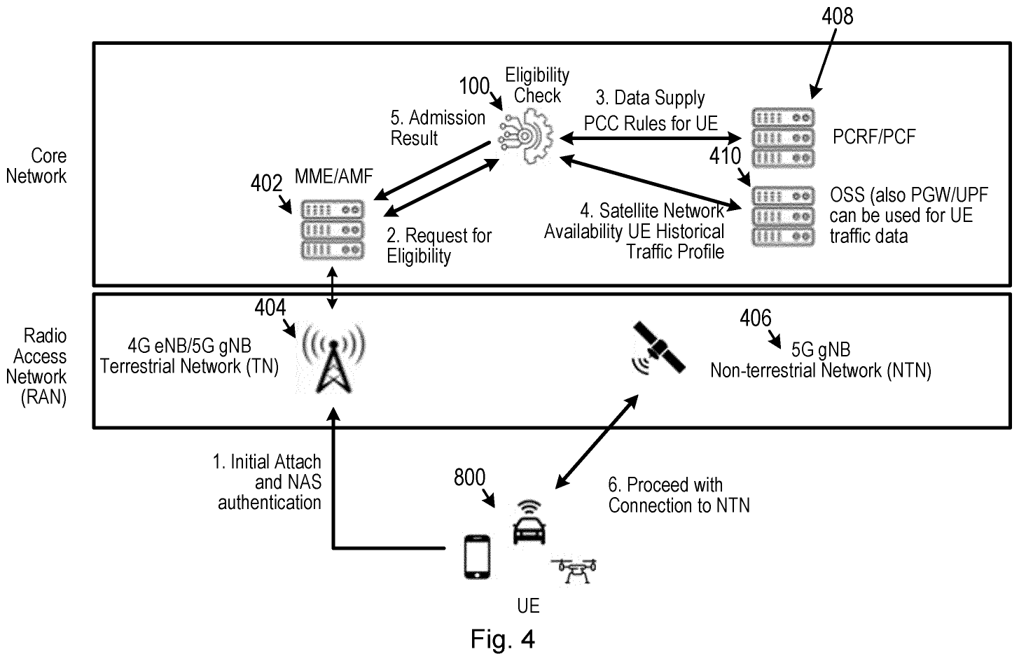

As another example, step 204 may be performed using a rules-based system. An example of a rules-based system is given by the pseudo code below in the example given with respect to FIG. 4.

Following the determination in step 204, the method 200 may further comprise sending a third message to a second node, for example, an orchestration node such as an MME or AMF in DC implementations, comprising an indication of whether the UE is allowed access, or denied access to the NTN, based on the result of determining whether to connect the UE to the NTN. The second node may then send further message(s) to the UE to instruct the UE on whether to connect to the NTN or the TN.

In this way the method 200 may be used to decide, for a UE, whether to steer traffic over the satellite network, i.e., NTN, link or terrestrial mobile network, i.e. TN, link. The system is based on predicting UE mobility and network coverage/availability and proactively enables UE to use one link over the other, based on spatiotemporal capacity of satellite network, traffic profile and mobility of the UE as well as the UE's requested QoS.

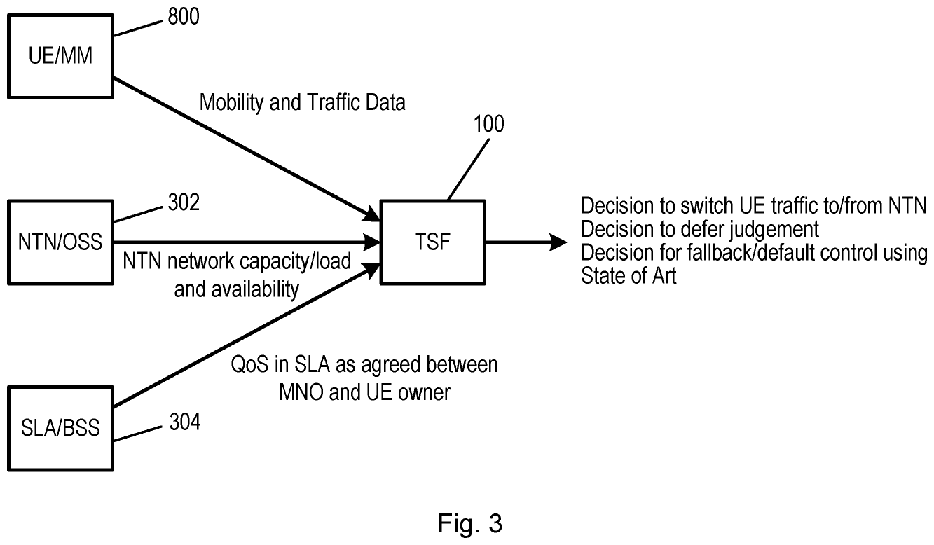

Turning now to FIG. 3 which shows an example first node 100 (labelled TSF in FIG. 1) performing the method 200 and determining whether a UE 800 is to connect to a NTN 302. The first node receives (step 202) Mobility and Traffic Data from the UE 800. This may comprise UE data traffic profile, bearing and velocity, and 4G (or 5G/6G) coverage maps. The first node further receives Load and availability of the satellite network for the current and future location of the UE. Since satellites are part of 5G network they can report this information to the Operations Support System (OSS 302). In this embodiment, the first node further receives UE traffic policies, which can be retrieved from the PCRF node 304. In this embodiment, for QoS the class identifier (QCI) priority, guaranteed bitrate, latency and packet drop rate are used.

The TSF 100 is an intelligent agent, that predicts the need for traffic steering based on the UE-related information supplied either by the UE itself or the mobility management (MM) network node responsible for tracking UE mobility; the NTN-related information on temporal capacity and availability supplied by the network management system, e.g., OSS, responsible for managing the NTN; and the Service Level Agreement (SLA)-related information on the network quality of service required by the UE and agreed beforehand between UE and operator. The Business Support System (BSS) provides this information. This approach naturally extends to the case of intent-driven network operations where this information is also available in a similar form.

The first node 100 then performs step 204 on the received data and determines whether UE 800 is to connect to the NTN. The first node outputs a decision, otherwise referred to herein as an action, which in this embodiment is selected from one of the following options:
switch to/from the NTN
defer judgement e.g., repeat the method 200 at a later time point, or
determine to fall back to the default control e.g., with NTN being unsupported.

Based on the above, the technical effect of the method 200 is to determine whether traffic steering between 5G TN and NTN should start, be deferred for some time in the future, or denied. In another embodiment, traffic steering can be denied or negotiated, in case of lack of resources on the NTN network.

The advantage of this approach is that it allows for better management of NTN resources which translates to reduced costs for the mobile operator and a more sustainable development of mobile networks. At the same time, QoS for UE does not need to be compromised in cases where there are ample available resources, whilst also accommodating situations where resources on the NTN are low.

Turning now to FIG. 4, the system in FIG. 3 is illustrated for a DC implementation. Appropriate nodes for both 4G and 5G implementations are indicated in FIG. 4. In DC, traffic steering is established by MME/AMF 402 establishing eligibility of UE 800 to attach to 5G TN network 404 5G NTN 406 by means of authentication. In this embodiment there is a first node/TSF 100. The TSF 100 decides whether to switch UE traffic between TN 404 and NTN 406, defer judgement for a later time, or do nothing, e.g., rely on existing approaches. The data input to the TSF 100 is provided by a Policy Control Function (PCF) or a Policy and Charging Rules Function (PCRF) 408 and an Operations Support System (OSS) 410.

In this embodiment, the method is performed by the first node as part of a DC process, in response to the first node receiving a second message comprising a Request for DC from a MME or an AMF.

FIG. 4 illustrates the process TSF 100 follows to provide an assessment of whether to admit a UE 800 to use 5G NTN 406. Arrows 2, 3, 4 and 5 illustrate new interfaces according to the methods herein, while arrows 1 and 2 show the existing DC admission process. The arrows may be summarised as follows:
Arrow 1: UE sends an initial attach and NAS authentication to the 4G/5G TN 404.
Arrow 2: MME/AMF 402 sends a request to the TSF to determine whether the UE is eligible for attachment.
Arrow 3: TSF receives QoS requirements of UE from PCRF/PCF 408
Arrow 4: TSF receives historical UE traffic profiles e.g., throughput requirements, and NTN capacity from OSS 410.
Arrow 5: TSF performs the method 200 on the received data and makes a determination of whether the UE should connect to the NTN, the TN, or whether the decision should be deferred.
Arrow 6: The decision is provided to the UE and, if allowed, the UE connects to the NTN.

TSF 100 is a logical function that can be collocated with the mobility management node (e.g., MME or AMF 402). Alternatively, TSF 100 can be part of network data and analytics function (NWDAF), which already has standardized interfaces towards the PCF. In addition, it can also be physically located at a third-party cloud server (not illustrated in the figure). In such case, it can retrieve data from the aforementioned nodes using a service exposure function such as a Service Capability Exposure Function (SCEF) or Network Exposure Function (NEF).

In this embodiment, there are two background processes taking place at TSF 100; one that predicts future data traffic for the UE using a first machine learning model, as described above with respect to the method 200, and the other that predicts the capacity of the satellite network (NTN 406) using a second machine learning model, as described above with respect to the method 200.

As data is gathered continuously, the first and second ML models are updated also continuously, e.g., retrained using weights from previous training as initial weights every X number of minutes or after Y “datums” of training data are collected. The process therefore resembles more that of continuous integration, wherein the model is trained and is made available to TSF operational component constantly, rather than a sequential process where the model is trained once.

When it comes to system operation, TSF assignment function is an algorithm triggered every time a new UE attaches to the network, sets its DCNR bit in UE-Network-Capability, and is authenticated by the mobility management function (e.g., MME). In this embodiment, the TSF 100 uses the following as input:
Predicted future capacity of NTN network, predicted future traffic profile for UE, as defined above. Note that the future capacity of NTN network is further parameterized by the “area”, as different areas may have different capacity.
Bearing and velocity of UE. In one embodiment, this information can both be extracted from the recent history of handovers from cell to cell, information contained already in the mobility management function.
Operator coverage map.
QoS policies for the UE, based on the Policy and Charging Control (PCC) rules stored in the Policy and Charging Rules Function (PCRF)/Policy Control Function (PCF).

In this embodiment, the TSF uses a rules-based system in step 202 of the method 200 and determines whether to connect the UE to the NTN based on the following pseudo-code:

```
Let FUT_NTN_CAP = { c₁, ..., cₓ}: c_{y}= [time_from, time_to, avail_trh_ul, avail_thr_dl,
    latency_ceiling_dl,   latency_ceiling_ul,packet_drop_rate_ul, packet_drop_rate_dl,
    area [a₁, ..., a_{z}]] for every c_{y} in FUT_NTN_CAP
Let FUT_UE_THR = {t₁, ..., t_{z}}: tₑ = [time_from, time_to, uplink_thr, downlink_trh] for every tₑ
in FUT_UE_THR
Let CV_map = { cv₁,..., cvₗ}: cv_{y} = [ [lat₁,long₁], ... , [latₓ,longₓ], quality] for every cv_{y} in
CV_map
Let QoS_policy = {pcc₁,..., pccₘ}: pccx = [throughput, traffic_direction, latency_ceiling,
    packet_drop_rate, prio]
Let UE_mobility = [current_position,bearing,velocity]
For c_current in FUT_NTN_CAP :
  If (c.current.time_from == 0 AND UE in area (c current.area, UE mobility.current position,
    UE mobility.bearing, UE mobility.velocity, LOOKAHEAD TIME) == TRUE):
    Find FUT_UE_THR [pred] using FUT_UE_THR.area and UE_mobility with FUT_UE_THR.time_from == 0
    If (c_current.avail_thr_ul >= FUT_UE_THR[pred].uplink_thr
    && c_current.avail_thr_dl >= FUT_UE_THR [pred].downlink_thr):
      For pcc_current in QoS_policy:
      If (pcc_current.packet_drop_rate >= c_current.packet_drop_rate_ul OR
          pcc_current.packet_drop_rate >= c_current.packt_drop_rate_dl OR
          pcc_current.latency_ceiling >= c_current.latency_ceiling_dl OR
          pcc_current.latency_ceiling >= c_current.latency_ceiling_ul)
                                set_defer_flag(true)
    If defer_flag == false
        return ALLOW;
else if UE in area (c current.area, UE mobility.current position, UE mobility.bearing,
UE_mobility.velocity, LOOKAHEAD TIME) == TRUE:
  Find FUT_UE_THR [pred] using FUT_UE_THR. area and UE_mobility with FUT_UE_THR.time_from >=
c.current.time_from
  If (c_current.avail_thr_ul >= FUT_UE_THR[pred].uplink_thr &&
  c_current. avail_thr_dl >= FUT_UE_THR[pred].downlink_thr):
    For pcc_current in QoS_policy:
        If (pcc_current.packet_drop_rate >= c_current.packet_drop_rate_ul OR
          pcc_current.packet_drop_rate >= c_current.packt_drop_rate_dl OR
          pcc_current.latency_ceiling >= c_current.latency_ceiling_dl OR
          pcc_current.latency_ceiling >= c_current.latency_ceiling_ul)
                                set_defer_flag(true)
    If defer_flag == true
      return DEFER [c.current.time_from];
Return DENY;
```

In this embodiment, a check is initially performed to determine whether the capacity of the satellite is enough for the UE to be admitted for DC. It does so by checking whether predicted capacity of satellite (for the next time quota) can cover the predicted throughput of the UE and whether the UE will be in the area of the predicted satellite capacity for at least a timespan equal to LOOKAHEAD TIME. In this embodiment this check is handled by the UE in area method, returning a Boolean.

If so, then UE is allowed for DC and process continues as per standards. If not, then the first node (e.g., TSF) checks whether the predicted capacity of the satellite will be enough sometime in the future in a similar way, and then the DC admittance is deferred for the future.

The skilled person will appreciate that the pseudo code above is merely an example and that there are other rules-based systems that may equally be used, dependent on the particular requirements of the communications network. Alternatively, the TSF 100 may implement a RL-agent, as described above with respect to the method 200.

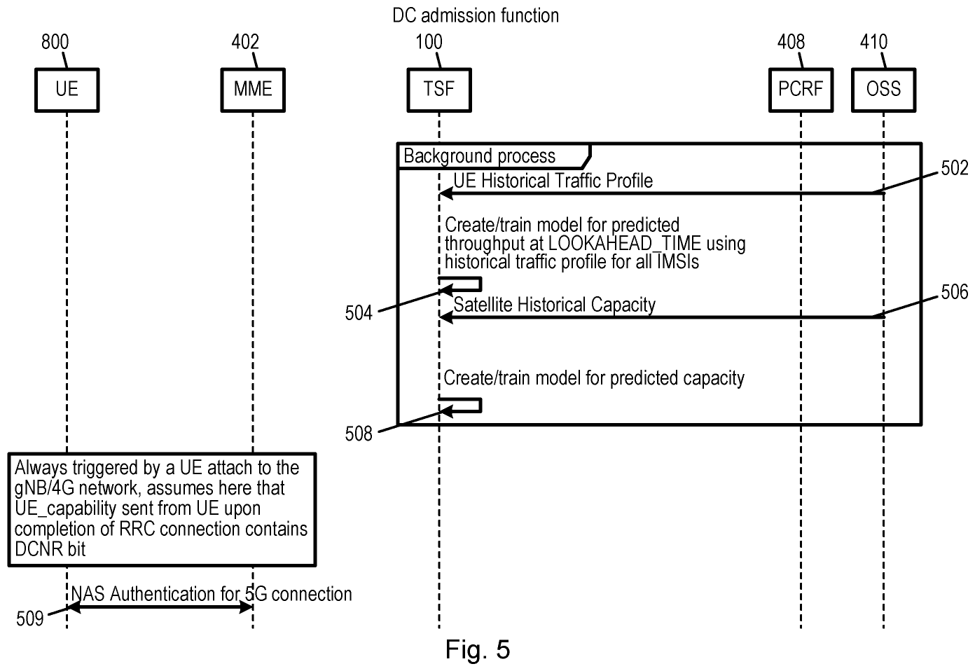

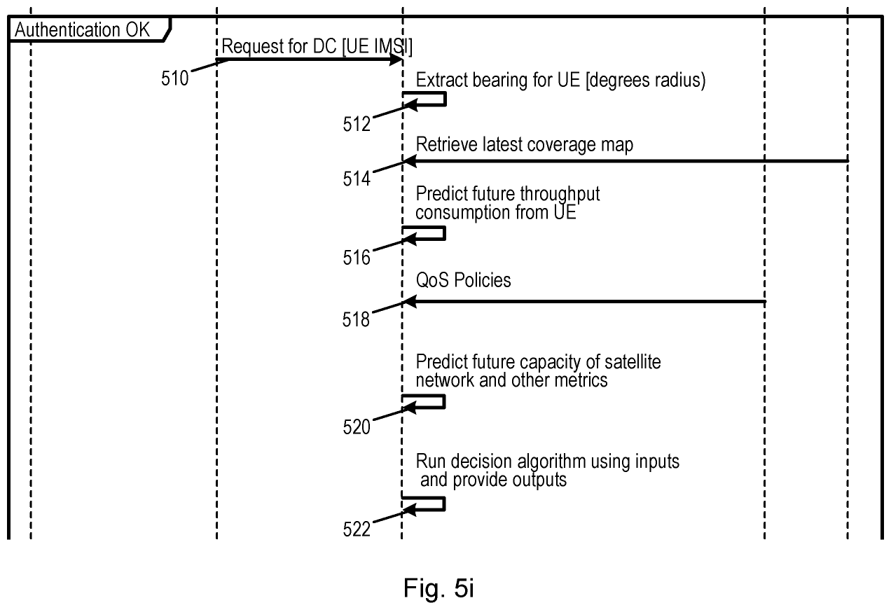

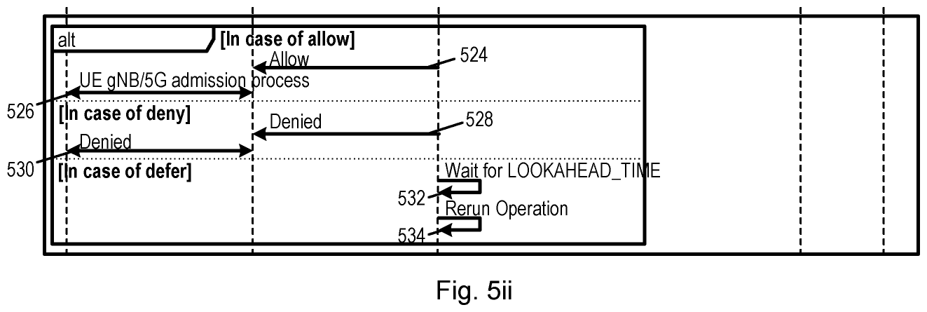

FIG. 5 illustrates a signal diagram between the entities shown in FIG. 4, according to an example embodiment.

In this embodiment the following processes are performed:
502: TSF 100 obtains UE historical traffic profile (ongoing background process). For example, the UE historical traffic profile may be in the form of a list comprising e.g., an IMIS, a throughput and a time, as items in the list.
504: TSF 100 trains a first model to predict UE throughput, using the received UE historical traffic profiles (ongoing background process).
506: TSF 100 obtains historical capacity of NTN to serve UE (ongoing background process). For example, the historical capacity may be in the form of a list comprising, any one or more of e.g., a IMSI, an available throughout, a latency, a packet drop rate, and a time as items in the list.
508: TSF 100 trains a second model to predict NTN capacity, using the received NTN historical capacity data (ongoing background process).
509: NAS Authentication is performed for the UE 800
510: TSF 100 receives a request for admission of UE 800 from MME 402.
512: TSF 100 obtains a location for the UE based on its bearing
514: TSF 100 receives coverage map for TN network from OSS 410. The coverage man can for example, be in the form of a list comprising e.g., a bounding box (e.g., a list comprising latitude and longitude) and, decibel, for example in milliwatts (dBm).
516: TSF 100 uses first model trained in step 504 to predict UE throughput consumption at a future time
518: PCRF 408 sends QoS requirements of UE to TSF 100. The QoS can be indicated for example in a list, e.g., as a QoS policy, comprising a priority, a guaranteed bit rate, latency, and a packet drop rate as items in the list.
520: TSF 100 predicts future capacity of satellite (e.g., performs step 202 of the method 200) using second model trained in step 508. The predicated future capacity may comprise indications of an available throughput, a packet drop rate, and a latency.
522: TSF determines whether the UE should connect to the NTN (e.g., performs step 204 of the method 200, using any of the methods described above with respect to the method 200, e.g. a RL agent, or a process similar to the pseudocode outlined above).
524/528: decision allow/deny is communicated to MME 402
526/530: decision allow/deny (and subsequent attachment processes if applicable) are sent to UE 800.
532: If the TSF determines to defer the decision then the TSF waits for a first time interval
534: Following the first time interval, the TSF re-performs steps 512-522.

Note that to find out the area where the UE will be in when comparing the capacity of the satellite with the UE throughput, the algorithm uses UE mobility data and compares them with the predicted capacity of the satellite at the area where the UE is likely to be at the given time.

There can be different cases in how this deference is handled. In one case, the UE is readily admitted, but in another case, the algorithm is rerun for the UE at the given deference time. Finally, a decision is to deny a UE of DC in case its demands cannot be met by the capacity of the satellite connection.

In the embodiment illustrated in FIG. 5, the method 200 is triggered in the first node (or TSF) 100 by a second node 600. In the embodiment illustrated in FIG. 5, the second node 600 hosts the MME 402, but the second node could be any other node in the communications network configured to perform the steps set out herein.

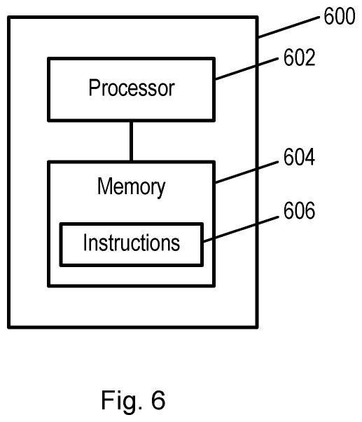

A schematic of a second node 600 is illustrated in FIG. 6. The second node 600 comprises a processor (e.g., processing circuitry or logic) 602. The processor 602 may control the operation of the second node 600 in the manner described herein. The processor 602 can comprise one or more processors, processing units, multi-core processors or modules that are configured or programmed to control the second node 600 in the manner described herein. In particular implementations, the processor 602 can comprise one or a plurality of computer programs and/or hardware modules that are each configured to perform, or are for performing, individual or multiple steps of the functionality of the second node 600 as described herein.

The second node 600 comprises a memory 604. In some embodiments, the memory 604 of the second node 600 can be configured to store a computer program 606 with program code or instructions that can be executed by the processor 602 of the second node 600 to perform the functionality described herein. Alternatively, or in addition, the memory 604 can be configured to store any requests, resources, information, data, signals, or similar that are described herein. The processor 602 may be configured to control the memory 604 to store any requests, resources, information, data, signals, or similar that are described herein.

It will be appreciated that the second node 600 may comprise one or more virtual machines running different software and/or processes. The second node 600 may therefore comprise one or more servers, switches and/or storage devices and/or may comprise cloud computing infrastructure or infrastructure configured to perform in a distributed manner, that runs the software and/or processes.

It will be appreciated that the second node 600 may comprise other components in addition or alternatively to those indicated in FIG. 6. For example, in some embodiments, the second node 600 may comprise a communications interface. A communications interface may be for use in communicating with other nodes e.g., via a communications network, (e.g. such as other physical or virtual computing nodes). For example, the communications interface may be configured to transmit to and/or receive from one or more nodes or network functions requests, resources, information, data, signals, or similar. The processor 602 may be configured to control such a communications interface to make/receive such transmissions.

In some embodiments, it will be appreciated that the second node may be implemented in hardware, e.g. completely in hardware. The second node 600 may be implemented in, (e.g., form part of, a communications network. In some embodiments herein, the second node 600, may be implemented in a management layer of a communications network. As noted above, the second node may be a host for MME 402 or an Access and Mobility Management Function, AMF.

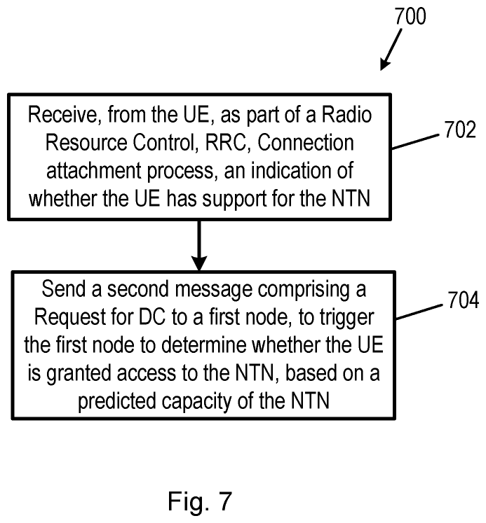

The second node is configured to perform the method 700 illustrated in FIG. 7. The method 700 comprises steps of: receiving 702, from the UE, as part of an RRC Connection attachment process, an indication of whether the UE has support for the NTN; and sending 704 a second message comprising a Request for DC to a first node, to trigger the first node to determine whether the UE is granted access to the NTN, based on a predicted capacity of the NTN.

In some embodiments, the indication may be an extension of the Dual Connectivity New Radio (DCNR) bit. For example, the DCNR bit may be extended so as to be two bits in size and one of the states of the DCNR indicates whether the UE has support for the NTN. Thus, in this way, the DCNR bit which is currently set to 0 (no support for 5G) and 1 (support for 5G) can be configured to receive a third state, thus increasing its size to two bits. The additional state would be whether it supports satellite communication (00 for 4G, 01 for 5G, 10 for Satellite communication, 11 unreserved). The usage of the enhanced bit will remain the same as-is with the addition now that the TN network will be able to determine the authentication of device more easily, or example, the equivalent of an NTN HSS can be hosted in a 3GPP network, and in addition make use of TSF to determine where the UE should be connected to.

In another embodiment, the indication may comprise a new piece of information, for example, such as a Dual Connectivity Non-Terrestrial Network, DCNTN, bit that indicates whether the UE has support for the NTN.

The skilled person will appreciate that these are merely examples however and that the indication may take other forms to the examples provided herein.

The method 700 may further comprise receiving a third message from the first node, the third message comprising an indication of whether the UE is allowed access, or denied access to the NTN, based on the result of determining whether to connect the UE to the NTN, by the first node. The second node may then instruct the UE to connect to the NTN (or the TN) depending on the indication.

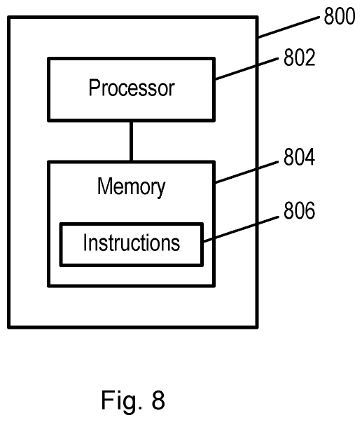

FIG. 8 illustrates a UE 800 according to some embodiments. The UE 800 comprises a processor (e.g., processing circuitry or logic) 802. The processor 802 may control the operation of the UE 800 in the manner described herein. The processor 802 can comprise one or more processors, processing units, multi-core processors or modules that are configured or programmed to control the UE 800 in the manner described herein. In particular implementations, the processor 802 can comprise a plurality of computer programs and/or hardware modules that are each configured to perform, or are for performing, individual or multiple steps of the functionality of the UE 800 as described herein.

The UE 800 comprises a memory 804. In some embodiments, the memory 804 of the UE 800 can be configured to store a computer program 806 with program code or instructions that can be executed by the processor 802 of the UE 800 to perform the functionality described herein. Alternatively, or in addition, the memory 804 can be configured to store any requests, resources, information, data, signals, or similar that are described herein. The processor 802 may be configured to control the memory 804 to store any requests, resources, information, data, signals, or similar that are described herein.

It will be appreciated that the UE 800 may comprise one or more virtual machines running different software and/or processes. The UE 800 may therefore comprise one or more servers, switches and/or storage devices and/or may comprise cloud computing infrastructure or infrastructure configured to perform in a distributed manner, that runs the software and/or processes.

It will be appreciated that the UE 800 may comprise other components in addition or alternatively to those indicated in FIG. 8. For example, in some embodiments, the UE 800 may comprise a communications interface. A communications interface may be for use in communicating with other nodes e.g., via a communications network, (e.g., such as other physical or virtual computing nodes). For example, the communications interface may be configured to transmit to and/or receive from nodes or network functions requests, resources, information, data, signals, or similar. The processor 802 may be configured to control such a communications interface to make/receive such transmissions.

A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g., refrigerators, televisions) personal wearables (e.g., watches, fitness trackers,). In other scenarios, a UE may represent a vehicle or other equipment that is capable of monitoring and/or reporting on its operational status or other functions associated with its operation. It will be appreciated that these are merely examples and that the UE may comprise other devices to those listed herein.

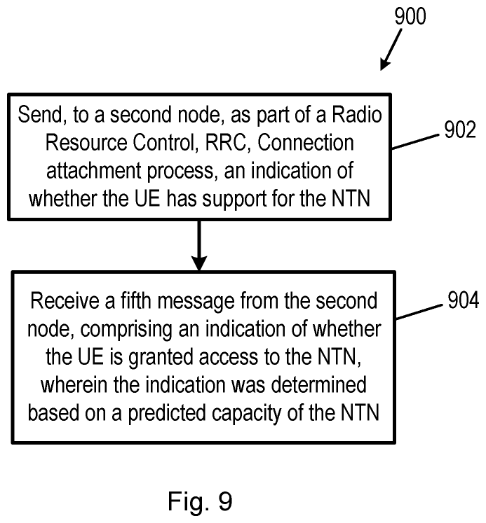

UE 800 may be configured to perform the method 900 shown in FIG. 9. For example, the UE 800 may be configured to send 902, to a second node, as part of an RRC Connection attachment process, an indication of whether the UE has support for the NTN; and receive 904 a message from the second node, comprising an indication of whether the UE is granted access to the NTN, wherein the indication was determined based on a predicted capacity of the NTN. This message may be referred to as a fifth message. The UE may thus connect to the NTN if the indication indicates that the UE is to connect to the NTN (e.g., if an allow notification is received).

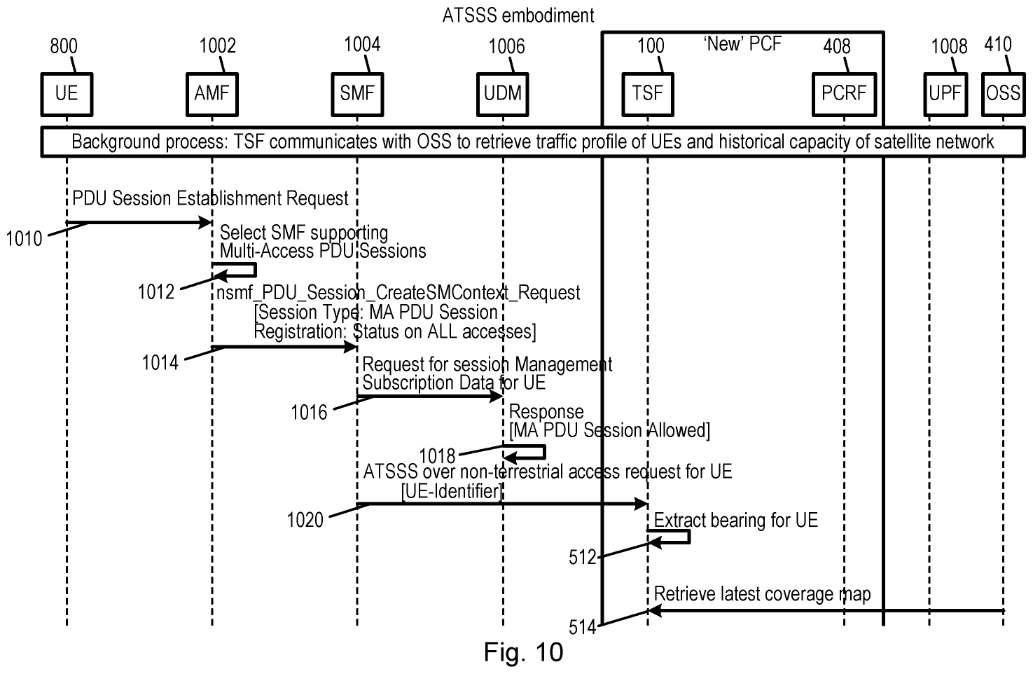

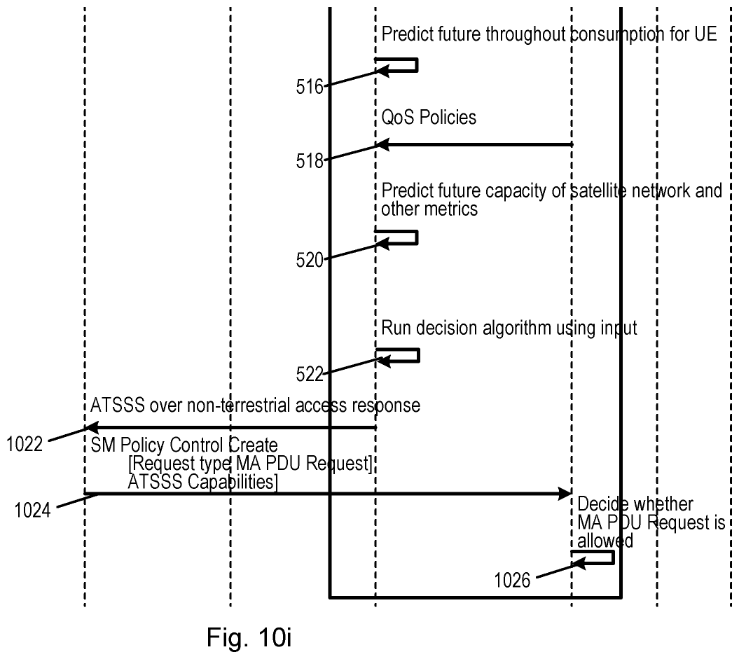

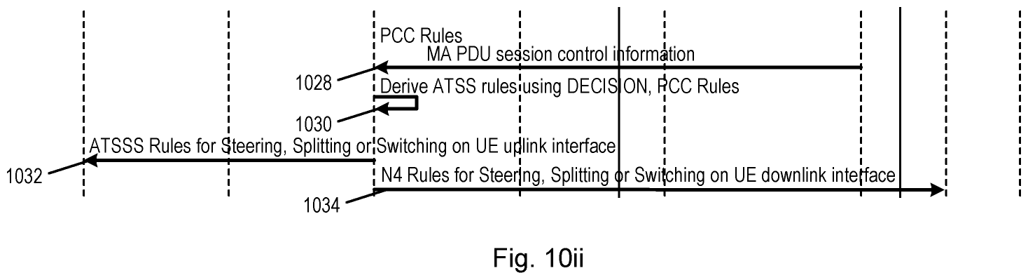

Turning now to FIG. 10 which illustrates another embodiment that uses the Access Traffic Steering, Switching and Splitting (ATSSS) framework, (3GPP TS 24.193). In this embodiment, the method 200 may be performed by a Policy Control Function, PCF, as part of an Access Traffic Steering, Switching and Splitting, ATSSS, procedure. The method 200 may be performed in response to receipt of a fourth message from a Session Management Function, SMF that indicates that the UE has requested a multi-access Protocol Data Unit, MA-PDU, request.

In this embodiment, there is a UE 800, an AMF 1002 a SMF 1004 a UDM 1006, a TSF 100, a PCF 408 a UPF 1008 and an OSS 410. The process follows the flow described in 3GPP TS 23.502, Procedures for the 5G System, Version 17.3.0. It is considered that NTN access is included among the list of accesses which are possible to be used for a certain UE (i.e., NTN access included in PCC rules for ATSSS).
1010: An ATSSS-capable UE requests a multi-access (MA) PDU session by sending a PDU Session Establishment Request over any of the available and authorized accesses (terrestrial or non-terrestrial). The UE also provides Request Type as “MA PDU Request” in the UL NAS Transport message and its ATSSS capabilities (ATSSS-LL and/or MPTCP functionality supported). The latter indicates the capability of UE to support multiple paths simultaneously.
1012/1014 The AMF 1002 informs the SMF 1004 that the UE 800 is requesting a MA PDU session.
1016/1018: The SMF determines the ATSSS capabilities supported for the MA PDU Session based on the ATSSS capabilities provided by the UE and based on allowed accesses.
1020: If non-terrestrial access is included among the accesses allowed for the UE, the TSF is contacted by sending an “ATSSS over non-terrestrial access request” including either a reference to the associated PCC rule or to a UE-identifier.
TSF 100 performs steps 512-522 as described above with respect to FIG. 5. The detail therein will be understood to apply equally to the embodiment in FIG. 10.
1022: The TSF provides an “ATSSS over non-terrestrial access response” including information of non-terrestrial access, e.g., predicted availability over time of NTN access, where availability could be in the form of predicted capacity, latency, throughput, packet error rate, etc.
1024-1034: The SMF uses the inputs from TSF (which are dynamically generated), together with PCC rules from PCF (obtained in steps 1024, 1026 and 1028), to derive the ATSSS rules for the UE (in step 1030) and N4 rules for the UPF. ATSSS/N4 rules are finally delivered to UE/UPF in steps 1032 and 1034.

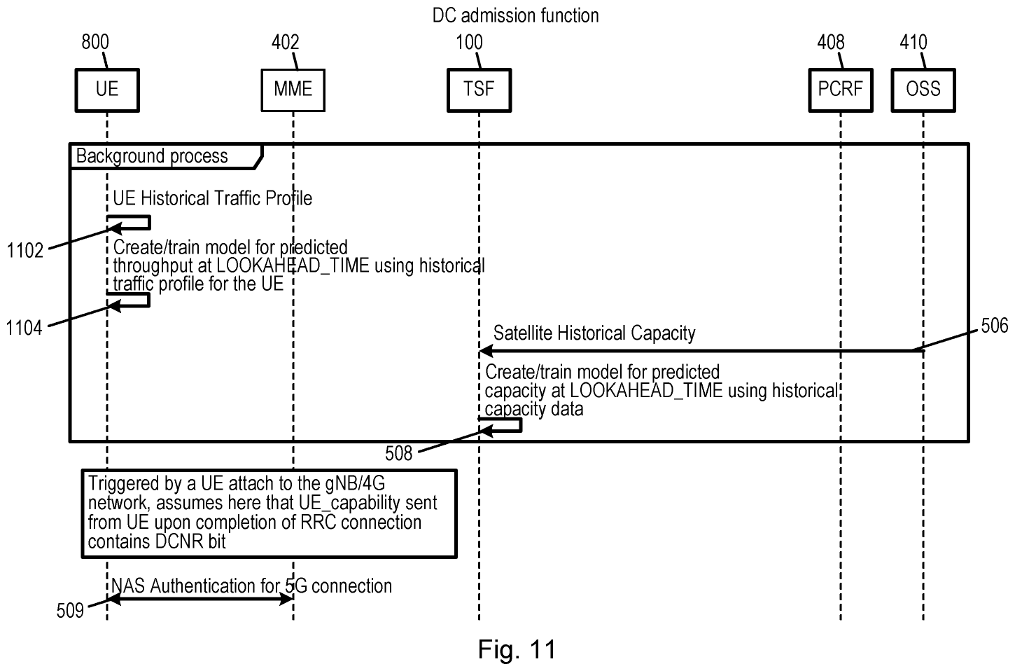

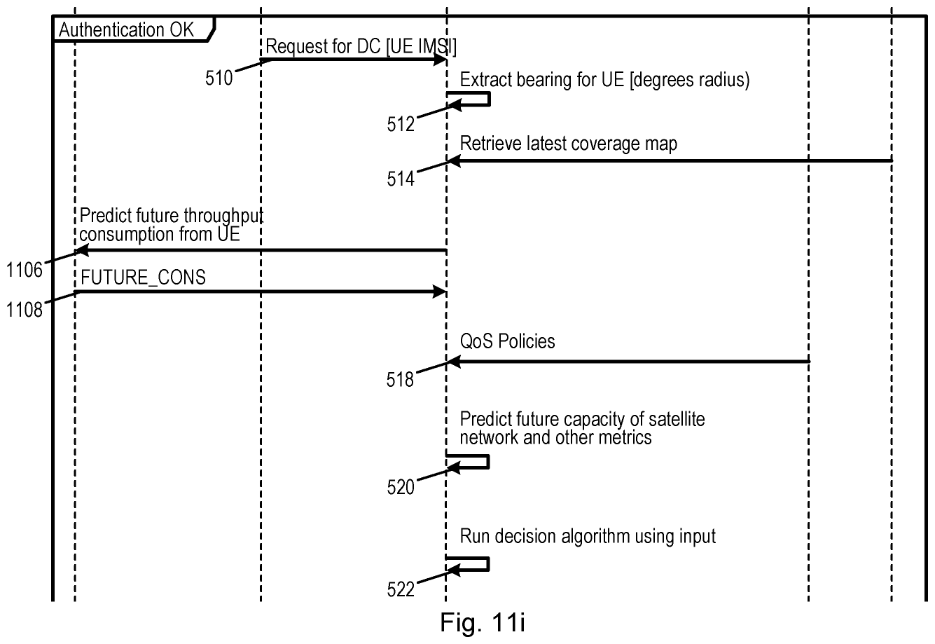

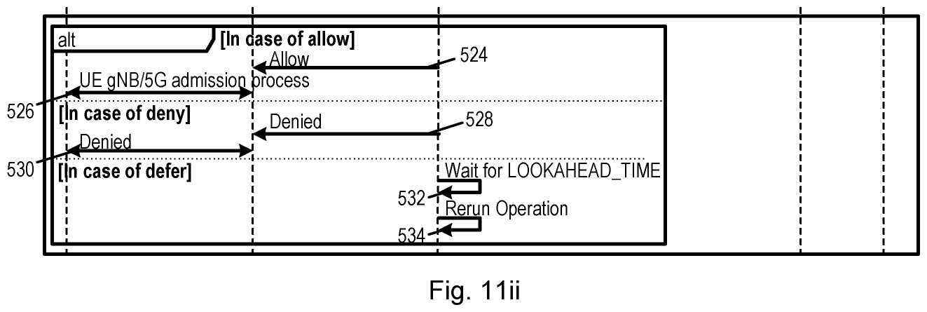

Turning now to other embodiments, FIG. 11 shows an example UE based implementation. In this embodiment, the UE predicts its own throughput. The embodiment is described with respect to the DC approach as described above, however a similar approach also applies to the ATSSS case. In this embodiment, TSF 100 assumes the role of the orchestrator as described below.

To improve on privacy and at the same generate more personalized models on the UE side the process for predicting the expected consumption of each UE, throughput wise, can be performed by the UE. To achieve this, the first two steps, 502; 504 shown in FIG. 5 can be altered to be performed by the UE itself as illustrated in steps 1102; 1104 in FIG. 11. The UE may then communicate the prediction to the TSF 1108 in response to a request 1106 by the TSF. These models are UE specific and do not require collecting UE data in a centralized location but instead train each forecasting model on the UE itself when the UE is idle/charging. In step 1108 the UE would then communicate it's forecast to the TSF function which is still responsible for determining if the UE should be attached to the TN/NTN network given the availability of that. TSF model is still required since that is meant to learn to determine available resources TN/NTN wise.

The other steps illustrated in FIG. 11 were described with respect to FIG. 5 above and the detail therein will be understood to apply equally to the embodiment of FIG. 11.

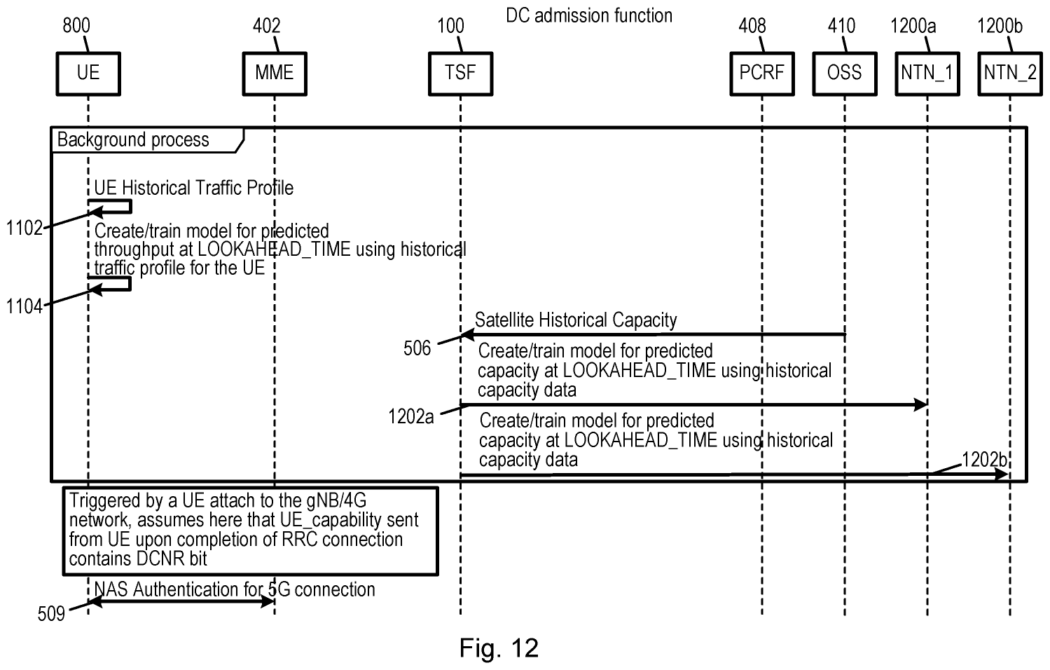

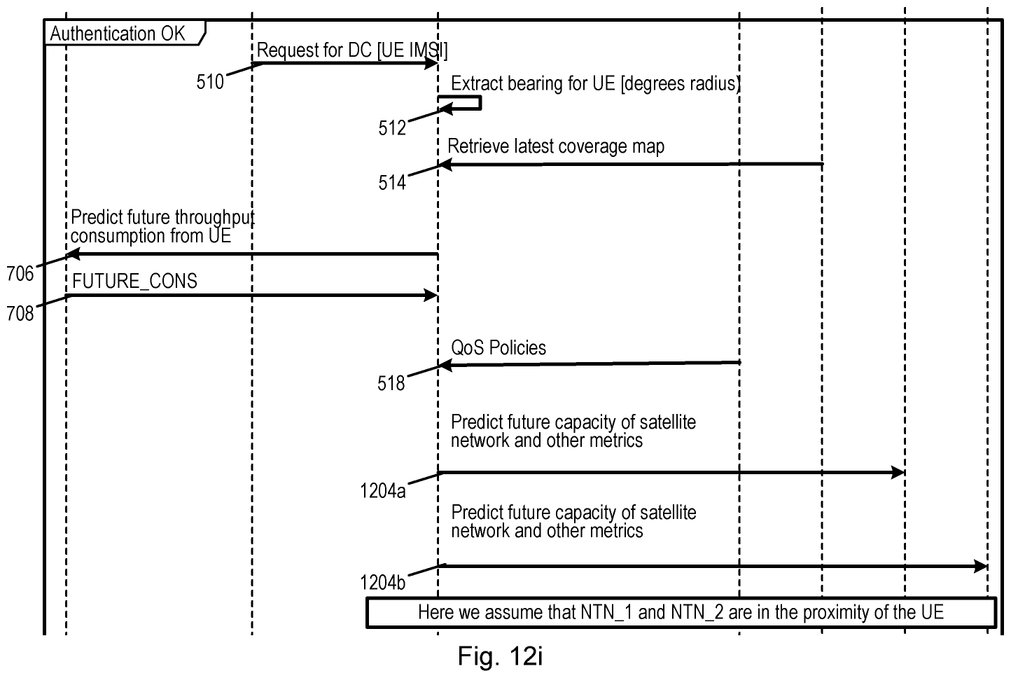

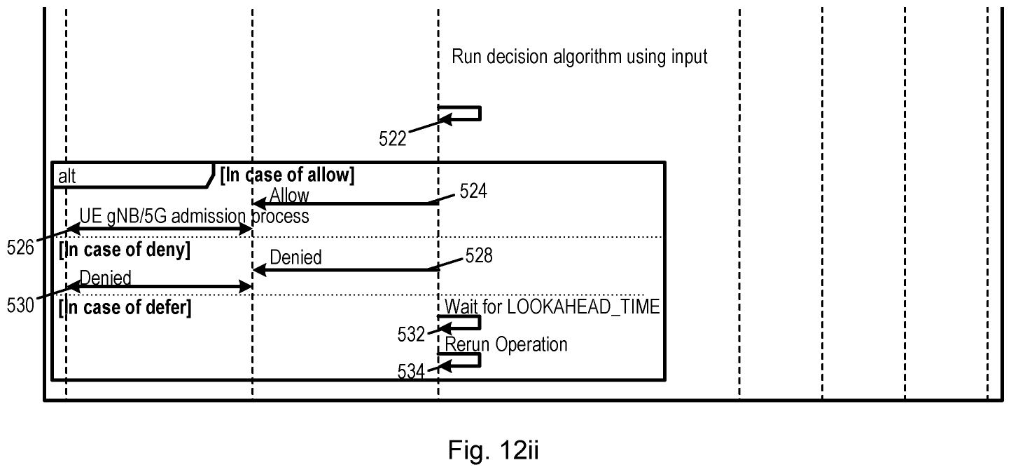

FIG. 12 shows another embodiment whereby TSF 100 bases its decision on local capacity prediction models in the respective NTNs 1200a; 1200b. This embodiment targets step 508 of FIG. 5, which is replaced by steps 1202a and 1202b in which the TSF 100 orchestrates the training of NTN capacity predictions models residing in NTN_1 1200a and NTN_2 1200b respectively. In steps 1204a and 1204b, assuming these NTNs are in proximity to the UE, TSF will request them to generate their corresponding forecast for capacity instead of using the original centralized approach described previously in FIG. 5.

The other steps illustrated in FIG. 12 were described with respect to FIG. 5 above and the detail therein will be understood to apply equally to the embodiment of FIG. 11.

Turning now to another embodiment, in the embodiments above, alternative solutions have been described to TN/NTN usage by considering that TN networks are cellular networks, either 4G or 5G. In this section, we describe another embodiment, wherein TN networks can offer Wireless Fidelity (Wi-Fi) access. In this case, mobile devices are known as STA (station). In such a case, the UE implementation of TSF embodiment illustrated in FIG. 9 can be used with the following alternative conventions:
Alternative A: All UE, MME, TSF, OSS, and PCRF nodes are parts of STA.
Alternative B: UE, MME and TSF nodes can be collocated in the STA node, whereas PCRF and OSS can be third party cloud services.

Turning now to other embodiments, there is also provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

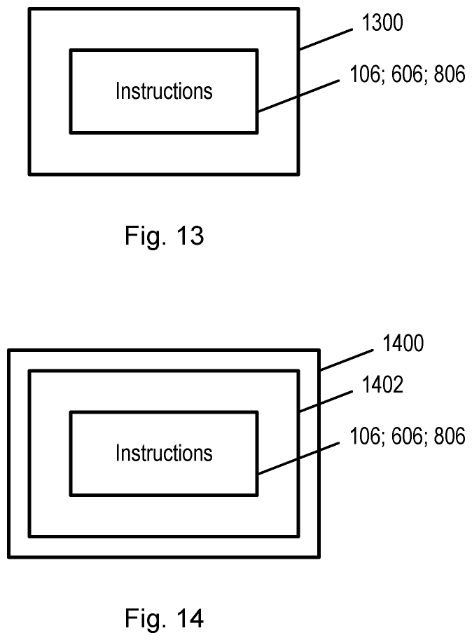

FIG. 13 shows a carrier 1300 containing a computer program 106; 606; 806. A carrier may be an electronic signal, optical signal, radio signal or computer readable storage medium.

The carrier of a computer program may be any entity or device capable of carrying the program. For example, the carrier may be or include a computer readable storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

FIG. 14 shows a computer program product 1400 comprising non transitory computer readable medium 1402 having stored thereon a computer program 106; 606; 806 as described above.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method performed by a first network node in a terrestrial network, TN, for determining whether a user equipment, UE, is to connect to a non-terrestrial network, NTN, the method comprising:
obtaining a predicted capacity of the NTN for transmissions made by the UE; and
determining whether to connect the UE to the NTN, based on the predicted capacity of the NTN.

2. The method according to claim 1, wherein the method further comprises obtaining UE parameters comprising one or more of:
a location for the UE;
a predicted throughput of the UE;
coverage of a terrestrial network, TN, at the location for the UE; and
a Quality of Service, QoS, requirement of the UE; and
wherein determining whether to connect the UE to the NTN is further based on the UE parameters.

3. The method according to claim 2, wherein determining whether to connect the UE to the NTN comprises:
determining an action, wherein the action indicates that:
the UE is to connect to the NTN;
the UE is to connect to the TN; or
the determination of whether to connect the UE to the NTN should be deferred for a first time interval.

4. The method according to claim 3, wherein determining whether to connect the UE to the NTN is performed using a discrete-time stochastic control process.

5. The method according to claim 4, wherein the discrete-time stochastic control process is a reinforcement learning, RL, process performed by a RL agent; and
wherein state information provided to the RL agent comprises: the predicted capacity of the NTN and the UE parameters; and wherein the action is output by the RL agent.

6. The method according to claim 5, wherein the RL agent receives feedback in the form of a reward and wherein:
an action that results in the QoS requirement of the UE being met results in a higher reward than an action that results in the QoS requirement of the UE not being met;
an action that results in the QoS requirement of the UE being met by the TN results in a higher reward than an action that results in the QoS requirement of the UE being met by the NTN;
an action that results in the QoS requirement not being met results in a negative reward;
an action that results in higher energy usage of the UE receiving a lower reward than an action that results in lower energy usage of the UE; and
an action that results in a higher transmission cost receiving a lower reward than an action that results in a lower transmission cost.

7. The method according to claim 3, wherein the action indicates that the decision should be deferred for the first time interval if the predicted throughput of the UE is less than the predicted capacity of the NTN, but the QoS requirement of the UE cannot be met by the NTN.

8. The method according to claim 2, wherein the method comprises obtaining the predicted throughput of the UE by:
predicting the throughput using a first model trained using a Machine Learning process that predicts the throughput at a predetermined future time interval, based on previous throughput of the UE; or
receiving the predicted throughput in a first message from the UE, wherein the UE has predicted the throughput using a first model trained using a Machine Learning process that predicts the throughput at a predetermined future time interval, based on previous throughput of the UE.

9. (canceled)

10. (canceled)

11. The method according to claim 8, wherein the first model is trained in real time on historical data for the UE and/or wherein the second model is trained in real time on historical data pertaining to whether the NTN historically had capacity for transmissions by the UE.

12. The method according to claim 2, comprising obtaining the location for the UE by predicting a location of the UE at a future time point, based on a trajectory of the UE, and wherein the predicted throughput of the UE and the predicted capacity of the NTN are predicted for the same future time point.

13. The method according to claim 1, wherein the method is performed by the first network node as part of a dual connectivity, DC, process, in response to the first network node receiving a second message comprising a Request for DC from a Mobility Management Entity, MME or an Access and Mobility Management Function, AMF.

14. The method according to claim 13, further comprising:
sending a third message to the respective MME or AMF, comprising an indication of whether the UE is allowed access, or denied access to the NTN, based on the result of determining whether to connect the UE to the NTN.

15. The method according to claim 13, performed by an MME or AMF hosted by the first network node.

16. (canceled)

17. The method according to claim 1, wherein the method is performed by a Policy Control Function, PCF, as part of an Access Traffic Steering, Switching and Splitting, ATSSS, procedure;
wherein the method is performed in response to receipt of a fourth message from a Session Management Function, SMF; and
wherein the fourth message indicates that the UE has requested a multi-access Protocol Data Unit, MA-PDU, request.

18. A method performed by a second network node in a Terrestrial Network, TN, for determining whether a user equipment, UE, is to connect to a non-terrestrial network, NTN, the method comprising:
receiving, from the UE, as part of a Radio Resource Control, RRC, Connection attachment process, an indication of whether the UE has support for the NTN; and
sending a second message comprising a Request for DC to a first network node, to trigger the network first node to determine whether the UE is granted access to the NTN, based on a predicted capacity of the NTN.

19. The method according to claim 18, wherein the indication comprises a Dual Connectivity Non-Terrestrial Network, DCNTN, bit that indicates whether the UE has support for the NTN; or wherein the indication is comprises in an extended Dual Connectivity New Radio, DCNR, bit wherein one of the states of the extended DCNR bit indicates whether the UE has support for the NTN.

20. The method according to claim 18, wherein the method further comprises receiving a third message from the first network node, the third message comprising an indication of whether the UE is allowed access, or denied access to the NTN, based on the result of determining whether to connect the UE to the NTN.

21. The method according to claim 18, wherein the method is performed by a Mobility Management Entity, MME or an Access and Mobility Management Function, AMF hosted on the second network node.

22.-33. (canceled)

34. A second network node in a Terrestrial Network, TN, for determining whether a user equipment, UE, is to connect to a non-terrestrial network, NTN, the second network node comprising:
a memory comprising instruction data representing a set of instructions; and
a processor configured to communicate with the memory and to execute the set of instructions, wherein the set of instructions, when executed by the processor, cause the processor to:
receive, from the UE, as part of a Radio Resource Control, RRC, Connection attachment process, an indication of whether the UE has support for the NTN; and
send a second message comprising a Request for DC to a first network node, to trigger the first network node to determine whether the UE is granted access to the NTN, based on a predicted capacity of the NTN.

35. (canceled)

36. (canceled)

37. A User Equipment, UE, in a Terrestrial Network, TN, for determining whether the UE, is to connect to a non-terrestrial network, NTN, the UE comprising:
a memory comprising instruction data representing a set of instructions; and
a processor configured to communicate with the memory and to execute the set of instructions, wherein the set of instructions, when executed by the processor, cause the processor to:
send, to a second network node, as part of a Radio Resource Control, RRC, Connection attachment process, an indication of whether the UE has support for the NTN; and
receive a message from the second network node, comprising an indication of whether the UE is granted access to the NTN, wherein the indication was determined based on a predicted capacity of the NTN.

38. (canceled)
